(19) United States
(12) Patent Application Publication
(10) Pub. No.: US 2026/0030933 A1
(43) Pub. Date: Jan. 29, 2026

(54) METHOD FOR COLLECTING DATA FROM VEHICLES

(71) Applicant: Volkswagen Aktiengesellschaft, Wolfsburg (DE)

(72) Inventors: Christopher VOX, Braunschweig (DE); Jan PIEWEK, Magdeburg (DE)

(73) Assignee: Volkswagen Aktiengesellschaft, Wolfsburg (DE)

(21) Appl. No.: 19/350,510

(22) Filed: Oct. 6, 2025

Related U.S. Application Data
(63) Continuation of application No. PCT/EP2024/057880, filed on Mar. 22, 2024.

(30) Foreign Application Priority Data
Apr. 5, 2023 (DE) 10 2023 203 193.0

(51) Int. Cl. G07C 5/00; G06V 20/56

(52) U.S. Cl. CPC G07C 5/008; G06V 20/56

(57) ABSTRACT

A method for collecting data from vehicles. Data sets are ascertained of at least one respective sensor of a plurality of vehicles. A respective feature vector is ascertained of the data sets. A respective compressed representation is ascertained of the feature vectors. The compressed representation is compared with a blacklist and/or a whitelist.

This nonprovisional application is a continuation of International Application No. PCT/EP2024/057880, which was filed on Mar. 22, 2024, and which claims priority to German Patent Application No. 10 2023 203 193.0, which was filed in Germany on Apr. 5, 2023, and which are both herein incorporated by reference.

### BACKGROUND OF THE INVENTION

### Field of the Invention

The present invention relates to a method and a device for collecting data from vehicles according to the independent claims.

### Description of the Background Art

In principle, methods are known for collecting data from vehicles, preferably for the training of neural networks that are required for autonomous driving, in particular. Typically, these data sets are captured by cameras mounted on vehicles and are sent to a central analysis unit, wherein enormous quantities of data must be transmitted, stored, and processed.

The demand in this case is to collect the best possible data sets as efficiently as possible, which represents a difficult task on account of the vehicle environments that occur with different frequencies.

For example, CN 110324804 B shows a communication system in which a multiplicity of vehicles are incorporated, wherein a decision as to whether the data are forwarded to a central analysis unit is made within the framework of each vehicle. The vehicles connect to a sensor network for this purpose.

U.S. Pat. No. 11,157,655 B2 describes a system and a method for verifying a hash chain that is used for data authentication.

EP 3 934 203 A1 describes a decentralized storage system in which data in the vehicle are locally buffered and stored. For this purpose, filters, for example Bloom filters, are used, with the aid of which it is possible to determine whether data are discarded or are forwarded.

### SUMMARY OF THE INVENTION

Based on the abovementioned prior art, the object of the present invention is to improve a method and a device for collecting data from vehicles such that data collection is designed as efficiently and intelligently as possible in order to collect balanced data as efficiently as possible.

The aforementioned object is attained by a method for collecting data from vehicles, wherein the method includes an ascertaining, in other words collecting, of data sets from at least one respective sensor of a multiplicity of vehicles. The multiplicity of vehicles is preferably at least two, preferably at least five, further preferably at least ten vehicles. According to the invention, each vehicle includes at least one sensor. Advantageously, each vehicle can include multiple sensors. The sensor is preferably a camera. The sensor is designed to capture data of the vehicle. For example, at least one sensor can be designed as a lidar sensor or a radar sensor. The data can preferably be image data and/or lidar data and/or radar data.

A data set should be understood as a collection of data, preferably data describing the environment of the respective vehicle on which the corresponding sensor is arranged. In this context, a data set includes data from only one vehicle, preferably from at least one or multiple sensors of the vehicle. For instance, individual images, video sequences, measured values of the sensor, and quantities or memory cell contents that are calculated from the measured values and/or sensor data can be considered as a data set. The data set can thus relate to an individual point in time up to a period of time. It can furthermore include the raw data of the at least one sensor as well as data derived therefrom. Preferably, the data set can be composed of an individual image from a sensor designed as a camera or of an image sequence or video sequence. In addition to possible image and/or video data, a data set furthermore can include additional data from at least one additional sensor of the vehicle, for example the corresponding GPS position of the vehicle, the vehicle speed, the braking torques of the vehicle, and/or the time of the data capture. Consequently, a place and a time preferably can be associated with each data set.

The method includes an ascertaining of a respective feature vector of the data sets. In other words, a feature vector is ascertained for each data set. For example, a program code can be used that generates, from the acquired data, a feature vector that abstractly describes the acquired data. Moreover, from the feature vector, this program code generates a still further abstracted, compressed representation that likewise describes the acquired data abstractly.

The feature vector can be based on, e.g., a semantic interpretation of pixels from an object detection (classification) or from another method for segmentation and classification of the image present by way of example in a data set. But other forms and algorithms for image processing/video processing likewise can be used for interpretation of the data. For example, filter algorithms, thresholding, cluster algorithms (DBSCAN, kmeans, . . . ), edge detection algorithms, and even deep neural networks should be considered here.

This can apply especially when the data sets are image data and/or video data of the environment of the relevant vehicle. Preferably, this is image data of a single frame. In other words, the pixels of the image data and/or video data are analyzed. Preferably, it is possible to associate a class with each pixel, which class describes the environment that is represented with the aid of the pixel. In this case, the pixels differ primarily in their coloring as regards the different classes. Furthermore, the method can include an object detection, preferably by means of at least one selected, algorithmic data-analyzing process. For example, the object detection can be based on lidar data. Certain classes can be associated with pixels on the basis of the detected objects within the framework of the object detection.

For example, the classes road, sky, vegetation, or pedestrian can be associated with pixels. A feature vector can include the percentage pixel content of the identified classes. Thus, a feature vector can include, for example, the percentage pixel content of a first class at a first location, the percentage pixel content of a second class at a second location, the percentage pixel content of a third class at a third location, and the percentage pixel contents of possible additional classes at additional locations. A concrete example would be 30% sky, 15% vegetation, 20% road, 5% pedestrian.

In addition, metadata (e.g., aperture, exposure time, etc.) and/or statistical parameters (minima, medians, maxima of the individual color components and/or brightness information), for example, can be used as features. Thus, first the color components of an image, for example, can be determined in one step, and in another step these components can be statistically analyzed in order to obtain at least one statistical parameter as a feature.

Furthermore, the feature vector can be based on vehicle speed and braking torque of the respective vehicle. For example, the feature vector can include the position data of two opposite corners of a rectangular bounding box that results from GPS position data.

Statistical features, as for example minima, maxima and/or medians of the vehicle speed and/or of the braking torques and/or their derivative can be included in the feature vector. Features can also include derivatives for characterizing a time range.

In addition, the feature vector can be based on minima and/or maxima and/or medians of measured value curves of a respective data set. For example, measured value curves from groups of sensors regarding minima, median, and maxima can be summarized. Minima and/or maxima or medians of the percentage pixel contents of a semantic interpretation, for example, can also be ascertained.

A feature vector summarizes important information about the data set, wherein this makes possible classification of the situation, but does not have the demand to be able to reconstruct the data set from the feature vector. A feature can also be the maximum speed of the vehicle in a time interval, for example.

Above all, the method includes a prior definition of the feature vector so that all feature vectors of all vehicles are calculated identically and are thus comparable. The same applies to the compressed representation. The definition thereof preferably is also defined in advance. Furthermore, different feature vectors can be defined and consequently different data sets can be collected.

The method includes the ascertaining of a respective compressed representation of the feature vectors. In other words, a compressed representation is generated of each feature vector. The compressed representation is, in particular, a summary of the feature vector. For example, a compressed representation of the feature vector can summarize entries of the vector. For example, each feature can be converted into a 2-bit representation. In order to create the compressed representation, primarily a hash function can be used, the input of which is a feature vector, and the output of which is the compressed representation, preferably a hash. In particular, a hash function is a function that maps a multiplicity of input values onto a smaller target quantity, in particular onto permanently defined, preferably integer, hash values.

The compressed representation preferably can be a single value, primarily a number, preferably an integer number. In this process, features can be excluded from the summary. For example, it is possible to summarize only features that relate to an analysis of the image data and/or video data, while other features are excluded from the summary; this relates to, e.g., the time and/or location of the data capture and/or other special conditions in this context such as, e.g., airbag triggering and/or vehicle data such as a maximum speed.

Preferably, the method can include a comparison of the compressed representation with a blacklist and/or a whitelist. This is accomplished, in particular, in an analysis unit assigned to the respective vehicle, preferably a local analysis unit. The local analysis unit furthermore serves to ascertain the feature vectors and the compressed representations regarding the data captured with the at least one sensor of the vehicle. The compressed representations thus generated are then compared with the aid of the local analysis unit. In addition to a higher-level analysis unit, therefore, a local analysis unit can exist for each vehicle that can compare the compressed representations with the blacklist and/or a whitelist. As a result, the goal is pursued of relieving the database in the higher-level analysis unit of queries. The method can include a selection of compressed representations that are not located on the blacklist and/or on the whitelist. Therefore, compressed representations are encompassed that do not appear on the blacklist and/or do appear on the whitelist. The selected compressed representations can then be sent to the higher-level analysis unit.

A blacklist should be understood as a list with unwanted compressed representations whose data should not be collected. A whitelist, in contrast, specifies compressed representations that are desired, since their associated data and features should be transmitted at all events—preferably regardless of the number of data sets already collected in the higher-level analysis unit. In particular, the blacklist and/or the whitelist can be sent by the higher-level analysis unit to the analysis units associated with the respective vehicles. For example, the higher-level analysis unit can include a blacklist with all compressed representations for which a maximum number of data sets has already been reached. The compressed representations for which this is not the case can be entered in the whitelist. If the higher-level analysis unit already has compressed representations with the values 1 through 7 and 9 and 10, for example, it is lacking a compressed representation with the hash value 8, for example, which consequently can be placed on a whitelist. Preferably, a comparison with the whitelist is carried out first, and then a comparison with the blacklist.

Preferably, the data sets and/or feature vectors of only selected data sets are transmitted. For the purpose of a balanced data set, redundancy can therefore be avoided beforehand, as early as within the framework of the local analysis unit.

The method preferably includes a sending of the compressed representations to a higher-level analysis unit and a comparison of the compressed representations with one another and/or the comparison of the compressed representation with already stored compressed representations, wherein a selection of desired compressed representations takes place on the basis of the comparison. Subsequently, a sending of the data sets of the selected compressed representations to a higher-level analysis unit takes place. In addition to the data sets of the selected compressed representation, the corresponding feature vector can also be sent to the analysis unit.

The analysis unit can be a decentralized or centralized analysis unit. It is associated with all vehicles, and therefore is higher-level. In this context, the higher-level analysis unit can be modular and/or be distributed over multiple locations, e.g., vehicles. Preferably, it is a back end, especially a cloud. The analysis unit preferably is not part of one of the vehicles. There can also be multiple higher-level analysis units, and a portion of the vehicles can be associated with at least one analysis unit.

The compressed representations are sent to the analysis unit, and to be specific, only the compressed representations preferably are sent in a first step. The feature vectors and the data sets are not sent to the analysis unit. Since the analysis unit preferably is not part of the vehicles, the analysis unit therefore collects the compressed representations of the entire multiplicity of vehicles. For this purpose, only a small quantity of data is transmitted, since the compressed representations constitute a far more reduced quantity of data than the feature vectors, to say nothing of the data sets. A comparison of the compressed representations with one another and/or a comparison with already stored compressed representations is now carried out by the analysis unit. Desired compressed representations can therefore be selected by means of the analysis unit.

The data to be transmitted are therefore reduced substantially by a sending of only the compressed representations instead of the data sets or the feature vectors. This is illustrated by the following example: Let it be assumed that an image in JPG format that is 100 KB in size is to be transmitted. The feature vector could include 32 features that each are implemented as 64-bit floating-point numbers, would therefore be over 256 bytes in size. For representation in compressed form, each feature is converted into a 2-bit representation. The resultant compressed representation is thus an 8-byte integer. Consequently, only 8 bytes are initially transmitted, and a determination is made therewith as to whether the image (100 KB) and the feature vector (256 bytes) should actually be sent. In the simplest case in the prior art, the 100 KB images are always transmitted and stored, wherein a data set for a training must then be selected from the collection. It is therefore to be expected that a majority of the images thus transmitted and stored are never selected for a training data set.

A selection of desired compressed representations is intended to recognize redundant information as early as possible. It can be the case that multiple sensors, preferably from different vehicles, have captured very similar information from the environment, since the vehicles are very close to one another for capturing the data. When a vehicle is stopped, for example, redundant data can arise from different points in time, since the same situation is captured at different points in time. If, for example, two compressed representations are identical, one of the two compressed representations can be classified as redundant, since even the underlying feature vector or data set cannot provide any further information. The compressed representations are thus compared directly with each other, and in the case of identity of the compressed representations, all but one compressed representation are classified as redundant and thus unwanted. In the case of difference between the compressed representations, they can each be classed as desired.

The comparison of the compressed representation with previously stored compressed representations is preferably a database matching. A database can exist that already includes previously captured and stored compressed representations, and preferably is being expanded with new, unique compressed representations. The compressed representations preferably are stored in the higher-level analysis unit. Furthermore, the higher-level analysis unit advantageously includes a data set counter that contains the number of associated stored data sets for each compressed representation. The data set counter is increased by 1 upon storage of a data set of a corresponding compressed representation. Furthermore, a maximum number of data sets to be collected can be defined for each compressed representation.

A balance of the collected data can be intentionally influenced by defining the maximum number individually for each compressed representation. This is especially advantageous, since less-frequent scenes of the environment can therefore be included more equally in a collection of data sets. Especially since the collection of data sets preferably is used for training a neural network for autonomous driving of the vehicle, it is essential to ensure that the data set collection includes an adequate number of data sets that describe rare situations.

Furthermore, the higher-level analysis unit can contain the feature vectors and the storage location of each dataset linked to the compressed representation. Furthermore, a compressed representation can be associated with the feature vectors and the corresponding data sets, for example through the file name or a folder name, wherein the file name or the folder name then must include at least the compressed representation as a component.

A compressed representation can then be classified as desired when, for example, the maximum number of data sets has not yet been reached, which can be determined by means of the data set counter. Conversely, all compressed representations that have not been classified as unwanted can also be classified as desired, wherein the representations that are redundant or in regards to which the maximum number of data sets has been reached are classified as unwanted. Desired compressed representations are selected.

In particular, the analysis unit can prompt the respective vehicle to send the data sets and, if necessary, also the feature vectors of the selected compressed representations, wherein the sending of the data sets and possibly the feature vectors for the selected compressed representations to the analysis unit then takes place.

Preferably, the compressed representation is a hash. For example, features, or in other words entries, of the feature vector can be summarized, for example added. The compressed representation thus occupies less memory space. Consequently, the hash is a newly compressed representation of the feature vector, and thus of the data set. Preferably, the hash is an integer. Preferably, numbers are associated with all possible values that features of the feature vector can assume. For example, a value range can be divided into ranges, wherein a value, for example an integer number, can be associated with each range. As a result, more complex features can be mapped onto less complex features, for example integer numbers, in a first step. In a next step, these values, for example the integer numbers, can be added so that the hash constitutes a single integer number, for example.

For example, percentages can be converted into an integer representation by means of threshold values. For example, different ranges can be defined with regard to percent values between 0 and 100, wherein, for example, the smallest integer can be associated with the lowest range, and the largest integer with the highest range, and integers therebetween with the ranges in between. For example, the 0 can be associated with the value 0%, the 1 with the range greater than 0% and less than or equal to 30%, the 2 with the range greater than 30% and less than or equal to 60%, and the value 3 with the range greater than 60%. The hash can now represent the total of the numbers thus obtained.

Furthermore, additional conditions on the sending of data sets can be implemented together with the blacklist and/or whitelist. For example, an additional condition that ensures that data sets and/or feature vectors of particular compressed representations are always transmitted can be defined with respect to the whitelist and/or blacklist. For example, the whitelist can specify that compressed representations, feature vectors, and data sets regarding an airbag activation are always transmitted. Corresponding data sets and/or feature vectors are always transmitted in that case, regardless of what other features are present. The vehicle speed, for example, can also be a feature of a feature vector. If, for example, the vehicle speed is 0, the compressed representations and the feature vectors and/or the data sets could be not transmitted right from the outset, since it can be assumed that no vehicle-relevant environmental situations have been captured, but instead the vehicle is in a congestion situation, for example. This could be implemented by means of the blacklist.

Points in time and/or time periods when all compressed representations must be transmitted from the vehicles to the higher-level analysis unit can be defined. It is therefore not necessary for each compressed representation to be transmitted individually or to be transmitted immediately after ascertainment, but instead all compressed representations ascertained in a specific time window can be transmitted at the same time. For example, a transmission of the compressed representation can be carried out once per second. Such a batch transmission also makes it possible for data sets within the batch that have identical compressed representations as described above to already be discarded in advance through previous comparison. Already-transmitted compressed representations, or also their feature vectors and/or data sets, can be deleted at the analysis unit associated with each vehicle.

Furthermore, the method is designed for a reconfiguration. If, for example, it turns out that a change in the definition of the feature vector or the definition of the compressed representation is advantageous, this is possible at any time.

On the whole, the method thus makes possible an efficient and intelligent data collection from different vehicles as data suppliers. The transmission and storage of unneeded data is prevented. Furthermore, a data set collection results in which everyday situations are not collected unnecessarily often and consequently are collected in a balanced number in comparison with rare situations. The archiving of data sets that are superfluous for the purpose of a diverse, balanced data set therefore is preferably prevented as early as during data collection in the vehicle.

The transmitted compressed representations and, if applicable, the corresponding data sets and, further optionally, feature vectors are stored by the higher-level analysis unit. The method can include a definition of a training data set for a neural network from the stored data sets.

The invention additionally includes the possibility that multiple data sets are ascertained or collected in a vehicle. Consequently, many intelligent data collections are collected in parallel. A separate feature vector can be created for each data set. A data set can be associated with, e.g., a sensor of the vehicle or a characteristic value of the vehicle. Each data set collects a new compilation of the available digital values and sensor values in the vehicle, preferably has its own program code for ascertaining the data-set-specific feature vector, furthermore has program code for calculating the associated compressed representation, and has a corresponding database in the higher-level analysis unit. For example, one data set can have the objective of acquiring images from the front camera during vehicle operation, and another data set acquire sensor data during shifting operations in the transmission of the drive train of the vehicle. The collecting of a specific data set need not necessarily occur in all vehicles, but instead can also take place in only a portion of a vehicle fleet.

In another aspect, the invention relates to a device for collecting data from vehicles, wherein the device includes a respective sensor relative to a multiplicity of vehicles for ascertaining data sets. Each of the vehicles thus includes at least one corresponding sensor. Furthermore, the device includes one analysis unit per vehicle that is designed to ascertain a respective feature vector of each data set and to ascertain a respective compressed representation of the feature vectors. This is preferably the above-described local analysis unit for this purpose.

Furthermore, the device is designed to compare the compressed representations with one another and/or with already stored compressed representations. Furthermore, the device is designed to select the desired compressed representation on the basis of the comparison, and to send the data sets of the selected compressed representation to a higher-level analysis unit. Furthermore, the device is designed to carry out the above-described method. Above all, the device includes a higher-level analysis unit that serves to communicate with a multiplicity of vehicles and that is designed to compare the compressed representations with one another and/or with already stored compressed representations. Furthermore, it is designed to select desired compressed representations on the basis of the comparison, and to request the sending of the data sets of the selected compressed representations, and to associate the data sets with the compressed representations, and to store the data sets and/or feature vectors and/or compressed representations.

Each local analysis unit preferably can include its own generator for creating compressed representations. Furthermore, each analysis unit can include a local memory by which means at least compressed representations that are generated in a particular time period are temporarily stored, and thus can be compared with one another. Furthermore, the corresponding feature vectors and the corresponding data sets can be temporarily stored there in order to be transmitted to the higher-level analysis unit if necessary. Furthermore, the device includes an interface for transmission of the compressed representation and an interface for transmission of the data sets or feature vectors. The higher-level analysis unit can include a database that stores all compressed representations. Furthermore, the device can include a file system that serves the purpose of filing and organization of the compressed representations and preferably of feature vectors and/or data sets.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

The following show, purely schematically:

FIG. 1 shows a process diagram of a method for collecting data from vehicles;

FIG. 2 shows a device for collecting data from vehicles;

FIG. 3 shows data sets captured at different points in time by a sensor, the corresponding feature vectors and compressed representations; and

FIG. 4 shows data set, a feature vector, and a compressed representation of a situation.

### DETAILED DESCRIPTION

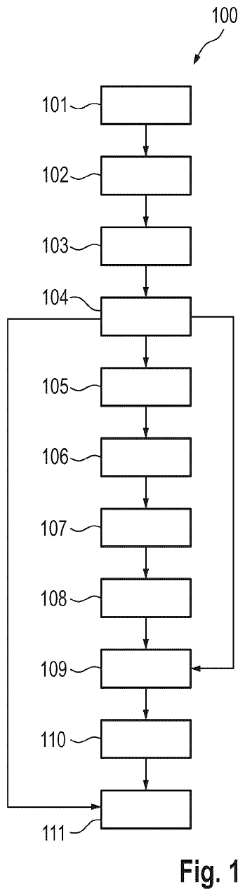

FIG. 1 shows a method 100 for collecting data from vehicles in which, in a first step, data sets of at least one respective sensor of a multiplicity of vehicles are first ascertained 101. Feature vectors are ascertained 102 from the data sets, and a compressed representation is generated 103 from each feature vector. Next, within the framework of a local analysis unit of each vehicle, the ascertained compressed representations from this vehicle can be compared 104 with a blacklist and/or a whitelist.

Compressed representations that are located on the blacklist can be deleted 111 directly in the temporary storage of the local analysis unit of the vehicle with the associated feature vectors and associated data sets.

Compressed representations that are located on the whitelist can be selected and transmitted 109 with the associated feature vectors and associated data sets directly to the higher-level analysis unit.

The compressed representations can be sent 105 directly to a higher-level analysis unit, wherein a comparison 106 of the compressed representations with one another and/or with previously stored compressed representations then takes place within the framework of the higher-level analysis unit. On the basis of the comparison, desired compressed representations are then selected 107, and the sending of the corresponding data sets of the selected compressed representation is requested 108, wherein the request is directed to the respective vehicle. For example, the number of already collected data sets and the defined maximum number for each compressed representation can be taken into account within the framework of the comparison. This is accomplished by a query of the database of the already-filed data sets. If data sets of a compressed representation are needed, this representation is selected as ‘desired’ and the associated data set is requested.

The requested data sets are then sent 109 to the higher-level analysis unit. The transmission request can be accomplished accordingly by means of a whitelist and/or by means of a comparison with preferably already-existing compressed data sets in a higher-level analysis unit, preferably in a database.

Between the sending and the requesting, the compressed representations, together with the feature vectors and/or data sets, are temporarily stored on the local analysis unit in the respective vehicle.

Sent data sets and/or feature vectors can be associated with the already-sent compressed representations, and the data sets and/or feature vectors and/or compressed representations can be stored 110 in the higher-level analysis unit.

If a feature vector or data set of a compressed representation is not requested and thus is not wanted, it can be deleted 111 from the temporary storage.

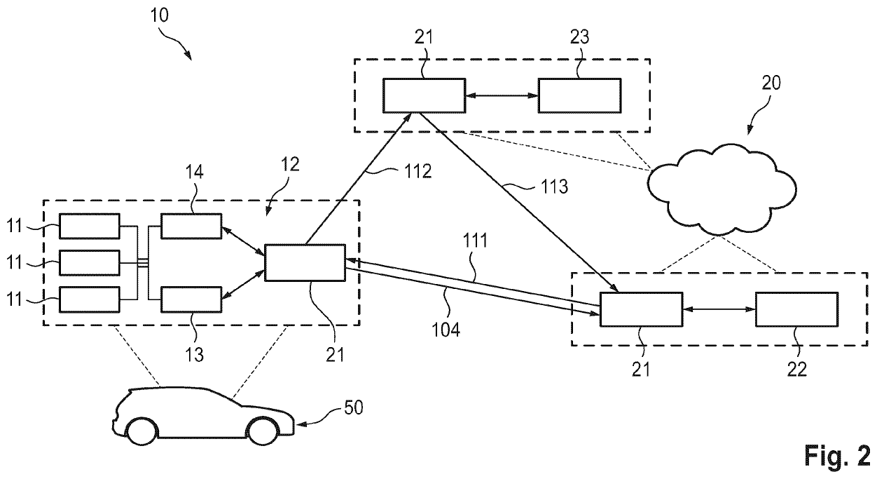

FIG. 2 represents a device 10 for collecting data from vehicles that includes various sensors 11, at least one sensor per vehicle. In FIG. 2, a vehicle 50 includes three depicted sensors 11, for example. The device 10 furthermore includes one local analysis unit 12 per vehicle that includes a memory unit 14 and a generator 13 for generating feature vectors and compressed representations. The device 10 furthermore includes an interface 21 for transmitting the compressed representations and preferably feature vectors and/or data sets to a higher-level analysis unit 20, which in this case constitutes a cloud.

The higher-level analysis unit 20, moreover, likewise includes two interfaces 21 for communication with the local analysis units 12, of which the local analysis unit 12 of the vehicle 50 is depicted in FIG. 2. Further included is also a database 22, in which feature vectors and/or data sets and/or compressed representations are already stored or will be stored. After sending 105 of the compressed representations, these representations are compared with the database 22. The data sets of selected compressed representations are requested 108 and transmitted 109 to the other interface 21 by means of the local analysis unit 12. An association 110 of the data sets with the compressed representations can then be carried out. Furthermore, the device 10 also includes a file system 23 for organization of the stored data.

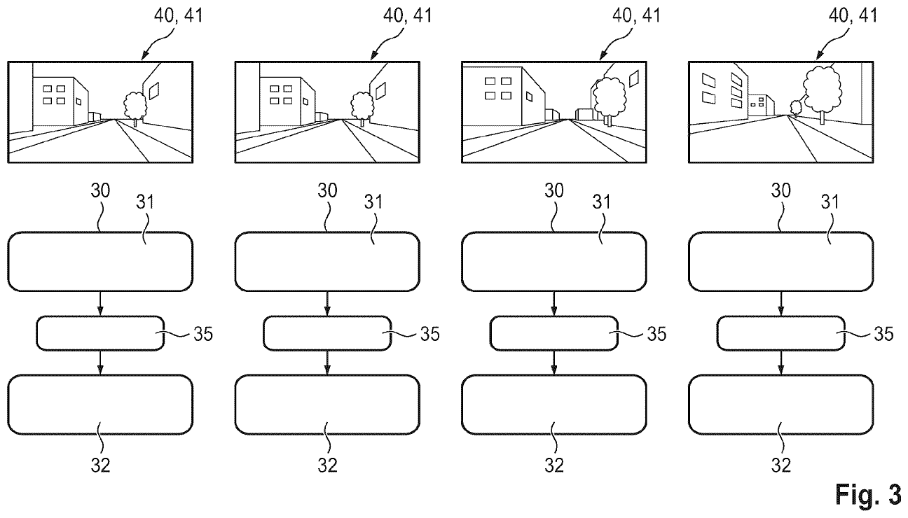

FIG. 3 shows data sets 40 captured at different points in time by means of a sensor, the corresponding feature vectors 30, and the compressed representations 32. The data sets 40 are images 41. These were captured at four different points in time, namely at a first point in time in the left-hand column, at a second point in time in the second column, at a third point in time in the third column, and at a fourth point in time in the right-hand column, which all follow one after the other.

In the row shown thereunder, the corresponding extracted feature vectors 30, which include a multiplicity of features 31, are depicted by way of example. The compressed representations 32 can be seen in the last row. They are created by a hash function 35, into which the feature vectors 30 are input. The compressed representations of the two left-hand images are identical, since the images are nearly identical, which can result from, e.g., a stoppage of the vehicle. This is determined by means of a comparison of the compressed representations, and just one sending of one of the corresponding data sets can take place, which substantially reduces the quantity of data to be transmitted.

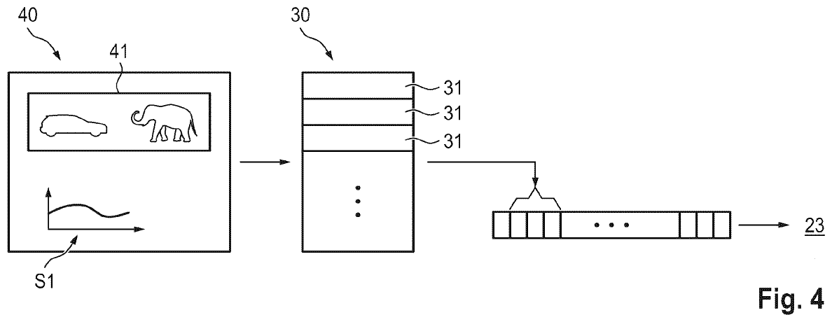

FIG. 4 shows a data set 40, a feature vector 30, and a compressed representation 32 of a situation. The data set 40 here includes, by way of example, an image 41 and a speed 51. The feature vector 30 can include various features 31 that relate to, e.g., the percentage class distribution of the pixels of the image 41. Here, the first feature could be 4% elephant and the second feature 10% sky, for example. A feature can relate to the maximum speed of the vehicle. These features are mapped onto a permanently defined value scale in order to obtain a compressed representation 32. For example, the number 0 can be associated with each value of the first feature below 10%, and the number 1 with each value above that. Similar provisions can apply for the other features.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method to collect data from vehicles, the method comprising:
ascertaining data sets from at least one respective sensor of at least two vehicles;
ascertaining a respective feature vector of the data sets;
ascertaining a respective compressed representation of the feature vectors; and
comparing the compressed representation with a blacklist and/or a whitelist.

2. The method according to claim 1, further comprising:
sending the compressed representations to a higher-level analysis unit;
comparing the compressed representations with one another and/or with already stored compressed representations;
selecting the desired compressed representations based on the comparison; and
requesting to send the data sets of the selected compressed representations.

3. The method according to claim 1, wherein the comparison of the compressed representation with a blacklist and/or a whitelist includes a selection of compressed representations that are not located on the blacklist and/or on the whitelist.

4. The method according to claim 2, wherein the method further comprises sending the data sets and/or feature vectors and/or compressed representations of the selected compressed representations to a higher-level analysis unit, and wherein the method further comprises associating the data sets with the compressed representations, and storing the data sets and/or feature vectors and/or compressed representations.

5. The method according to claim 2, wherein the method further comprises deleting compressed representations and/or feature vectors and/or data sets that are not selected.

6. The method according to claim 1, wherein the higher-level analysis unit does not represent a part of a vehicle.

7. The method according to claim 1, wherein the higher-level analysis unit is a back end.

8. The method according to claim 7, wherein the higher-level analysis unit is a cloud.

9. The method according to claim 1, wherein the data sets include image data of the environment of the vehicles, wherein the feature vector is based on a semantic interpretation of pixels of the image data.

10. The method according to claim 1, wherein the feature vector is based on a vehicle speed and/or a braking torque of the respective vehicle.

11. The method according to claim 1, wherein the feature vector is based on minima and/or maxima and/or medians of measured value curves of a respective data set.

12. The method according to claim 1, wherein a compressed representation is a hash.

13. A device for collecting data from vehicles, the device comprising:
a respective sensor relative to a plurality of vehicles to ascertain data sets, wherein the device is designed to ascertain a respective feature vector of the data sets, to ascertain a respective compressed representation of the feature vectors, and to compare the compressed representation with a blacklist and/or a whitelist.

14. The device according to claim 13, wherein the device sends the compressed representations to the higher-level analysis unit, wherein the device compares the compressed representations with one another and/or with already stored compressed representations, to select desired compressed representations on the basis of the comparison, and to send the data sets of the selected compressed representations to the higher-level analysis unit.

15. A device according designed to carry out the method according to claim 1.
